(19) United States
(12) Patent Application Publication
(10) Pub. No.: US 2026/0038757 A1
(43) Pub. Date: Feb. 5, 2026

(54) RELAY

(71) Applicant: Xiamen Hongfa Electric Power Controls Co., Ltd., Xiamen, Fujian (CN)

(72) Inventors: Shuming ZHONG, Xiamen, Fujian (CN); Guojin LIAO, Xiamen, Fujian (CN); Fangneng LI, Xiamen, Fujian (CN); Wenguang DAI, Xiamen, Fujian (CN)

(21) Appl. No.: 18/998,064

(22) PCT Filed: Aug. 2, 2023
(86) PCT No.: PCT/CN2023/110836

§ 371 Date: Jan. 23, 2025

(30) Foreign Application Priority Data
Aug. 3, 2022 (CN) 202210929404.3

(51) Int. Cl. H01H 47/04; H01H 50/54

(52) U.S. Cl. CPC H01H 47/04; H01H 50/54

(57) ABSTRACT

A relay includes a static contact and a movable contact assembly including a movable contact leading-out piece, a movable contact piece connected to the movable contact leading-out piece and a movable contact disposed at a side of one end of the movable contact piece. The movable contact piece is between the static contact and the movable contact leading-out piece for generating an electro-dynamic repulsion force therebetween under a short-circuit current, to allow the movable contact to abut against the static contact. Between the movable contact and a connection position of the movable contact piece with the movable contact leading-out piece, a distance from at least part of the movable contact leading-out piece to the movable contact piece is greater than a distance from portions of the movable contact leading-out piece located at both sides of the at least part to the movable contact piece.

### CROSS REFERENCE

The present disclosure is a national stage of International PCT Application No. PCT/CN2023/110836, filed on Aug. 2, 2023, which claims priority to Chinese Patent Application No. 202210929404.3, entitled “Relay” and filed on Aug. 3, 2022, which is incorporated herein by reference in its entirety.

### TECHNICAL FIELD

The present disclosure relates to a relay.

### BACKGROUND

A relay is an automatic switch and plays a role in automatically connecting and disconnecting a circuit. In the related art, in order to resist a repulsion force between contacts under a short-circuit current, a movable contact piece and a movable contact leading-out piece adopt a V-shaped structure, so that a current flowing through the movable contact piece and a current flowing through the movable contact leading-out piece must be in opposite directions, thereby generating an electro-dynamic repulsion force between the movable contact piece and the movable contact leading-out piece. When the short-circuit current is large enough, a region of the movable contact piece corresponding to the large electro-dynamic repulsion force may deform upwards, and due to a relatively fixed position of a static contact piece, a head of the movable contact piece deforms downwards, in which case a movable contact and a static contact generate staggered displacement, causing a change in contact resistance and leading to instability due to a short circuit. In addition, due to a downward movement of the head of the movable contact piece, the amount of angular of the movable contact piece becomes larger under compression, force transmitted to the push card is increased and, in severe cases, an armature will be pulled, so that the entire moving mechanism is driven to move, the movable and static contacts bounced off, explosion occurs, and safety during use is poor.

### SUMMARY

According to a first aspect of the present disclosure, a relay is provided, including a static contact; and a movable contact assembly. The movable contact assembly includes a movable contact leading-out piece, a movable contact piece, and a movable contact. The movable contact is disposed at a side of one end of the movable contact piece, facing the static contact. Another end of the movable contact piece is connected to the movable contact leading-out piece, and the movable contact piece is located between the static contact and the movable contact leading-out piece and is configured to generate an electro-dynamic repulsion force between the movable contact piece and the movable contact leading-out piece under a short-circuit current, to allow the movable contact to abut against the static contact. Between the movable contact and a connection position of the movable contact piece with the movable contact leading-out piece, a distance from at least part of the movable contact leading-out piece to the movable contact piece is greater than a distance from portions of the movable contact leading-out piece located at both sides of the at least part to the movable contact piece.

According to an embodiment of the present disclosure, wherein the distance from at least part of the movable contact leading-out piece to the movable contact piece refers to a distance from the movable contact to a straight line connecting the movable contact and the connection position of the movable contact piece with the movable contact leading-out piece when the movable contact and corresponding static contact are closed.

According to an embodiment of the present disclosure, the movable contact piece and the movable contact leading-out piece form a V-shaped structure.

According to an embodiment of the present disclosure, the movable contact leading-out piece includes: a middle section disposed between the movable contact and the connection position of the movable contact piece with the movable contact leading-out piece, the middle section being the at least part of the movable contact leading-out piece; a first connection section connected to another end of the movable contact piece; and a second connection section, the second connection section and the first connection section being respectively disposed at two sides of the middle section, and a position of the movable contact corresponds to the second connection section. A distance from a side of the middle section to a side of the movable contact piece close to the side of the middle section is d; a distance from a side of the first connection section to the side of the movable contact piece close to the side of the first connection section is d1; and a distance from a side of the second connection section to the side of the movable contact piece close to the side of the second connection section is d2, in which d>d1 and d>d2.

According to an embodiment of the present disclosure, a projection of the middle section on the movable contact piece does not coincide with a projection of the movable contact on the movable contact piece.

According to an embodiment of the present disclosure, the movable contact leading-out piece is recessed in a direction away from the movable contact piece, to form the middle section.

According to an embodiment of the present disclosure, the middle section is a groove with an open structure at one end, and an open end of the groove faces the movable contact piece.

According to an embodiment of the present disclosure, another part of the movable contact leading-out piece that is not provided with the groove is the first connection section and the second connection section.

According to an embodiment of the present disclosure, a groove wall of the groove is of an arcuate structure or a linear structure; and/or a groove bottom of the groove is of an arcuate structure or a linear structure.

According to an embodiment of the present disclosure, an end of the movable contact leading-out piece close to the movable contact at least partially protrudes toward a direction close to the movable contact piece, to form the second connection section.

According to an embodiment of the present disclosure, the second connection section includes a protrusion that protrudes relative to the movable contact leading-out piece and in a direction close to the movable contact piece, and the middle section is formed between a side wall of the protrusion close to the first connection section and the first connection section.

According to an embodiment of the present disclosure, a projection of the protrusion on the movable contact piece at least partially coincides with a projection of the movable contact on the movable contact piece.

According to an embodiment of the present disclosure, the projection of the protrusion on the movable contact piece completely coincides with the projection of the movable contact on the movable contact piece.

According to an embodiment of the present disclosure, a part of the projection of the protrusion on the movable contact piece beyond the projection of the movable contact on the movable contact piece is located at a side of the movable contact close to the connection position of the movable contact piece with the movable contact leading-out piece.

### BRIEF DESCRIPTION OF THE DRAWINGS

The above and other features and advantages of the present disclosure will become more apparent by describing in detail exemplary embodiments thereof with reference to the accompanying drawings.

FIG. 1 is a first structural schematic view of a relay according to a first embodiment of the present disclosure;

FIG. 2 is a structural schematic view of a relay in the related art as observed from an angle;

FIG. 3 is a second structural schematic view of the relay according to the first embodiment of the present disclosure;

FIG. 4 is a first structural schematic view illustrating a static contact assembly and a movable contact assembly of the relay according to the first embodiment of the present disclosure;

FIG. 5 is a second structural schematic view illustrating the static contact assembly and the movable contact assembly of the relay according to the first embodiment of the present disclosure;

FIG. 6 is a first structural schematic view of the movable contact assembly in the relay according to the first embodiment of the present disclosure;

FIG. 7 is a second structural schematic view of the movable contact assembly in the relay according to the first embodiment of the present disclosure;

FIG. 8 is a first structural schematic view of a movable contact leading-out piece in the relay according to the first embodiment of the present disclosure;

FIG. 9 is a second structural schematic view of the movable contact leading-out piece in the relay according to the first embodiment of the present disclosure;

FIG. 10 is a first structural schematic view illustrating a static contact assembly and a movable contact assembly of a relay according to a second embodiment of the present disclosure;

FIG. 11 is a second structural schematic view illustrating the static contact assembly and the movable contact assembly of the relay according to the second embodiment of the present disclosure;

FIG. 12 is a first structural schematic view of the movable contact assembly in the relay according to the second embodiment of the present disclosure;

FIG. 13 is a second structural schematic view of the movable contact assembly in the relay according to the second embodiment of the present disclosure;

FIG. 14 is a first structural schematic view of a movable contact leading-out piece in the relay according to the second embodiment of the present disclosure;

FIG. 15 is a second structural schematic view of the movable contact leading-out piece in the relay according to the second embodiment of the present disclosure;

FIG. 16 is a first structural schematic view illustrating a static contact assembly and a movable contact assembly of a relay according to a third embodiment of the present disclosure;

FIG. 17 is a second structural schematic view illustrating the static contact assembly and the movable contact assembly of the relay according to the third embodiment of the present disclosure;

FIG. 18 is a third structural schematic view illustrating the static contact assembly and the movable contact assembly of the relay according to the third embodiment of the present disclosure;

FIG. 19 is a structural schematic view of a movable contact leading-out piece in the relay according to the third embodiment of the present disclosure.

### REFERENCE NUMERALS

1′ static contact assembly; 2′ movable contact assembly; 11′ static contact piece; 12′ static contact; 21′ movable contact leading-out piece; 22′ movable contact piece; 23′ movable contact; 1 static contact assembly; 2 movable contact assembly; 11 static contact piece; 12 static contact; 21 movable contact leading-out piece; 22 movable contact piece; 23 movable contact; 211 middle section; 2111 groove; 212 first connection section; 213 second connection section; 2131 protrusion; 100 base; 101 push card; 102 armature assembly; 103 coil; 104 yoke; 105 pressing block; 106 pivot shaft; 107 socketed hole; 108 pressing rod; 109 microswitch; 110 conductive plug terminal.

### DETAILED DESCRIPTION

Exemplary embodiments will now be described more comprehensively with reference to the accompanying drawings. However, the exemplary embodiments can be implemented in various forms and should not be construed as being limited to the implementations set forth herein. Although relative terms such as “up” and “down” are used in this specification to describe the relative relationship of one marked component to another marked component, these terms are used in this specification for convenience only, for example, according to directions of examples described in the drawings. It can be understood that if a marked device is turned upside down, a component described as being “up” will become a component as being “down”. Other relative terms such as “top” and “bottom” also have similar meanings. When a structure is “on” another structure, it may mean that the structure is integrally formed on the other structure, or that the structure is “directly” disposed on the other structure, or that the structure is “indirectly” disposed on the other structure through another structure.

Terms “one,” “an/a,” “the” and “said” are used to indicate existence of one or more elements/components/the like. Terms “including” and “having” are used in the sense of open-ended inclusion and indicate there may be additional elements/components/the like besides the listed elements/components/the like. Terms such as “first” and “second” are used merely as markers and do not limit the number of the objects referred to.

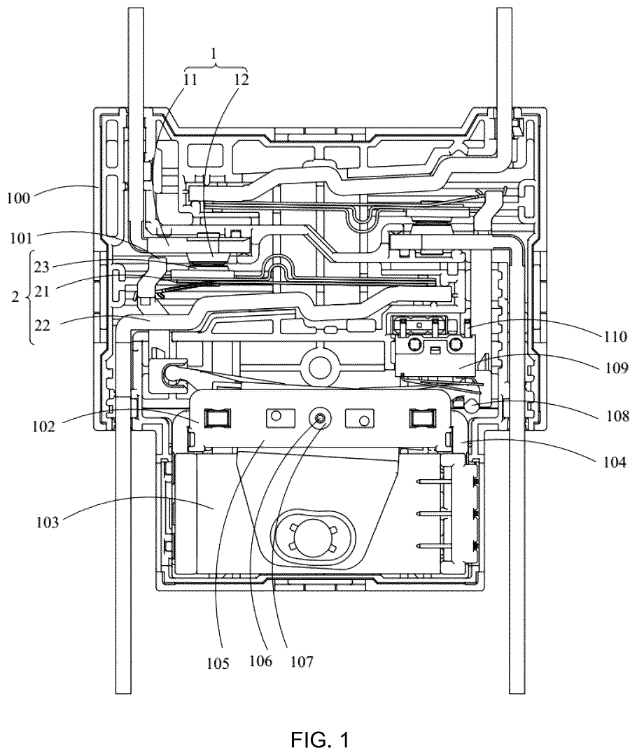

This embodiment provides a relay, as shown in FIG. 1, including a contact part. The contact part includes a movable contact assembly 2 and a static contact assembly 1. The static contact assembly 1 includes a rigid static contact piece 11 and a static contact 12; the static contact 12 is fixed at one end of the static contact piece 11; and another end of the static contact piece 11 extends to an outside of a base to serve as a lead-out piece of the static contact piece. The movable contact assembly 2 includes a rigid movable contact leading-out piece 21, a flexible movable contact piece 22 and a movable contact 23; the movable contact 23 is disposed at a side, facing the static contact 12, of one end of the movable contact piece 22; and another end of the movable contact piece 22 is connected to the movable contact leading-out piece 21. The movable contact piece 22 is located between the static contact 12 and the movable contact leading-out piece 21, and is configured to generate an electro-dynamic repulsion force between the movable contact piece 22 and the movable contact leading-out piece 21 under a short-circuit current. The movable contact piece 22 and the movable contact leading-out piece 21 form a V-shaped structure.

For the relay according to this embodiment, one end of the movable contact piece 22 is provided with the movable contact 23 at the side facing the static contact 12, that is, the movable contact 23 is fixed at one end of the movable contact piece 22 and corresponds to the static contact 12, and another end of the movable contact piece 22 is connected to the movable contact leading-out piece 21, so that the movable contact piece 22 and the movable contact leading-out piece 21 are connected as an integral structure. In the existence of current, since the movable contact leading-out piece 21 and the movable contact piece 22 forms a V shape, a current flowing through the movable contact leading-out piece 21 and a current flowing through the movable contact piece 22 must be in opposite directions, at which time the electro-dynamic repulsion force is generated between the movable contact leading-out piece 21 and the movable contact piece 22, and the electro-dynamic repulsion force acting on the movable contact piece 22 will increase pressure between the movable contact 23 and the static contact 12, thereby achieving an anti-short circuit ability.

It can be understood that another end of the movable contact piece 22 may be fixed to the movable contact leading-out piece 21 by rivets or the like, and for convenience of description, a connection position of another end of the movable contact piece 22 with the movable contact leading-out piece 21 is a riveting position.

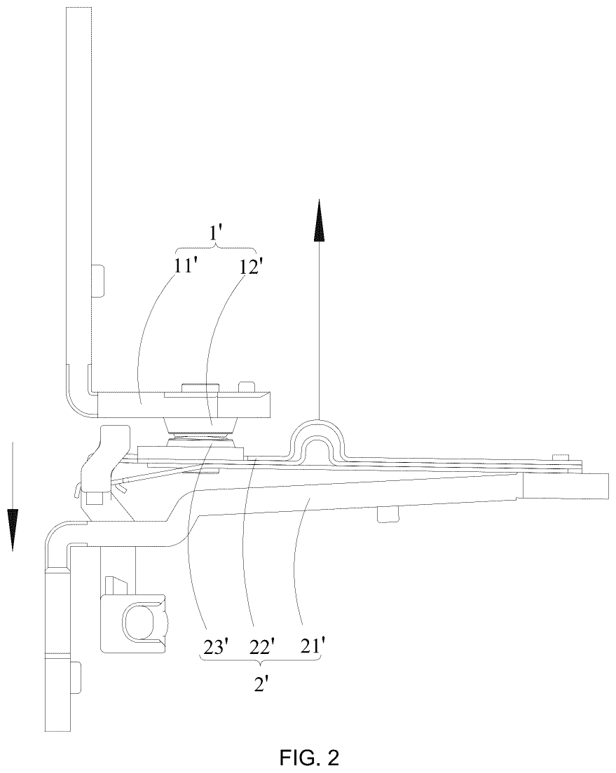

As shown in FIG. 2, in the related art, a static contact assembly 1′ includes a static contact piece 11′ and a static contact 12′; a movable contact assembly 2′ includes a movable contact leading-out piece 21′, a movable contact piece 22′ and a movable contact 23′; and a distance from the movable contact piece 22′ to the movable contact leading-out piece 21′ gradually increases in a direction from the riveting position to the movable contact 23′. If a short-circuit current between the movable contact 23′ and the static contact 12′ is relatively small, for example, less than 6 KA, when the short-circuit current passes through the movable contact piece 22′ and the movable contact leading-out piece 21′ that form the V-shaped structure, the movable contact piece 22′ will generate upward deformation, and the deformation may drive the movable contact 23′ to rub, thereby reducing an adhesive force between the movable contact 23′ and the static contact 12′.

If the short-circuit current between the movable contact 23′ and the static contact 12′ is relatively large, for example, greater than 10 KA, the electro-dynamic repulsion force between the movable contact 23′ and the static contact 12′ increases with the increase of the current. A distance from a side of the movable contact leading-out piece 21′ close to the riveting position to the movable contact piece 22′ is relatively small, so that the electro-dynamic repulsion force between the side of the movable contact leading-out piece 21′ close to the riveting position and the movable contact piece 22′ is relatively large, resulting in a relatively large amount of deformation of the movable contact piece 22′upward in this region. A distance from a side of the movable contact leading-out piece 21′ away from the riveting position to the movable contact piece 22′ is relatively large, so that the electro-dynamic repulsion force between the side of the movable contact leading-out piece 21′ away from the riveting position and the movable contact piece 22′ is relatively small. Since positions of the movable contact 23′ and the static contact 12′ are fixed to each other, the movable contact piece 22′ deforms downward in this region, making the movable contact 23′ and the static contact 12′ prone to staggered displacement, leading to a change in contact resistance, and leading to instability due to a short circuit and even explosions in severe cases. Since an end of the movable contact piece 22′ close to the movable contact 23′ moves downward, force transmitted to the push card is increased and, in severe cases, an armature will be pulled, so that the entire moving mechanism is driven to move, the movable contact 23′ and the static contact 12′ bounced off, and explosion occurs, thereby affecting the performance of the relay. At this time, an intermediate portion of the movable contact piece 22′ deforms upward, and both ends of the movable contact piece 22′ deform downward.

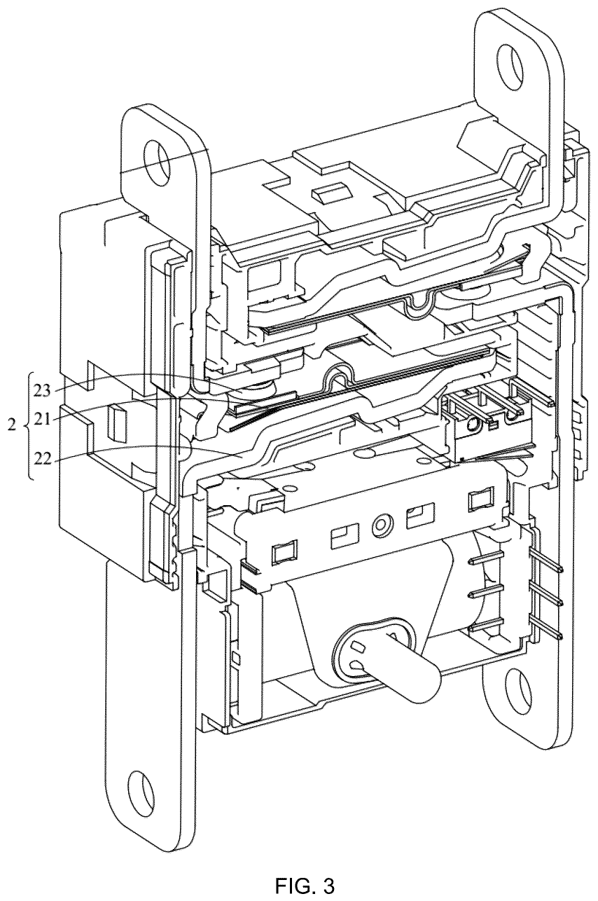

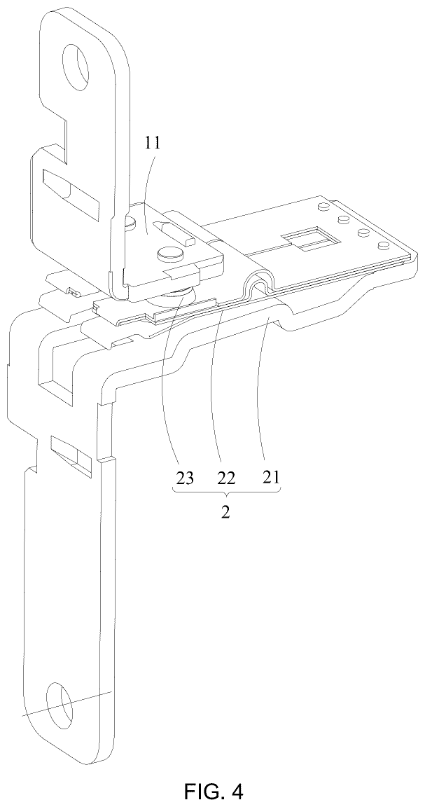

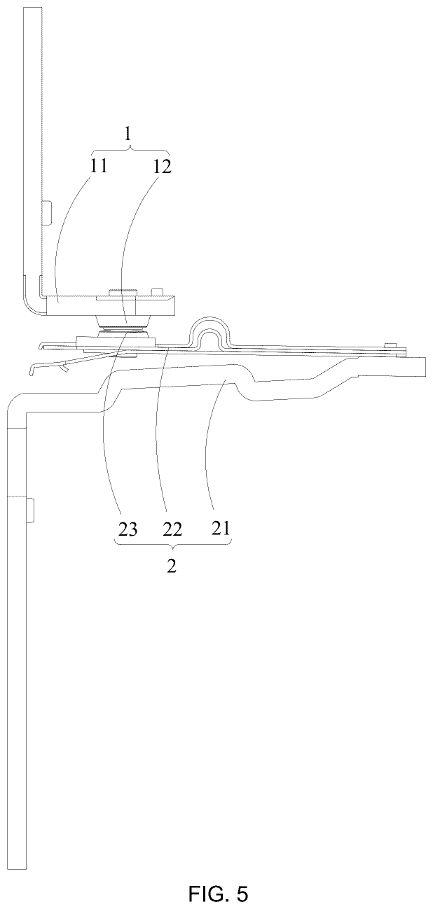

In order to solve the problem, in this embodiment, the structure of the movable contact leading-out piece 21 is optimized and improved. As shown in FIG. 3 to FIG. 5, between the movable contact 23 and the connection position of the movable contact piece 22 with the movable contact leading-out piece 21, a distance from at least part of the movable contact leading-out piece 21 to the movable contact piece 22 is greater than a distance from portions of the movable contact leading-out piece 21 located at both sides of the at least part to the movable contact piece 22.

When a short circuit occurs, after the current passing through the movable contact leading-out piece 21 reaches the riveting position between the movable contact piece 22 and the movable contact leading-out piece 21, the current is transmitted to the movable contact 23 through the movable contact piece 22. For the movable contact piece 22, the current may only exist between the riveting position of the movable contact piece 22 and the movable contact 23, so that a region between the movable contact 23 and the connection position of the movable contact piece 22 with the movable contact leading-out piece 21 can match with a region where the current may be generated, to limit a functional region of the movable contact piece 22. When a short-circuit current occurs, since the distance from at least part of the movable contact leading-out piece 21 to the movable contact piece 22 is relatively large, the electro-dynamic repulsion force between the at least part of the movable contact leading-out piece 21 and the movable contact piece 22 is relatively small, and the amount of deformation of the movable contact piece 22 in this region is relatively small, so as to achieve the purpose of reducing the upward deformation of the movable contact piece 22 in this region. Since the distance from portions of the movable contact leading-out piece 21 located at both sides of the at least part to the movable contact piece 22 is relatively small, the electro-dynamic repulsion force between the portions of the movable contact leading-out piece 21 located at both sides of the at least part and the movable contact piece 22 is relatively large, so that the amount of deformation of the movable contact piece 22 in this region is relatively large, and contact pressure between the movable contact 23 and the static contact 12 is relatively large, reducing a risk of staggered displacement occurring between the movable contact 23 and the static contact 12, reducing the occurrence of explosions due to the instability caused by the short circuit, and improving the safety during use of the relay.

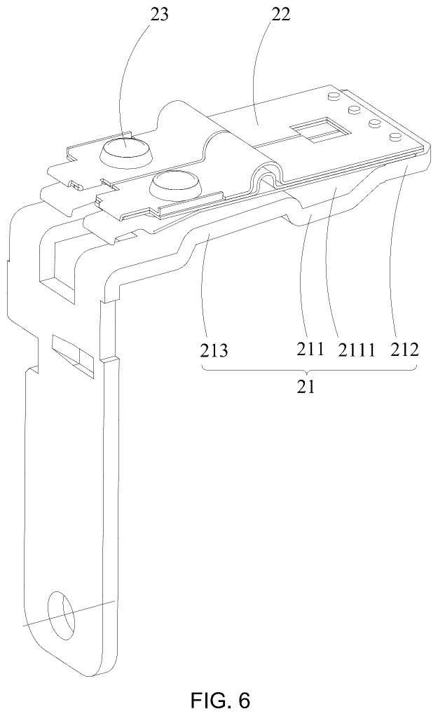

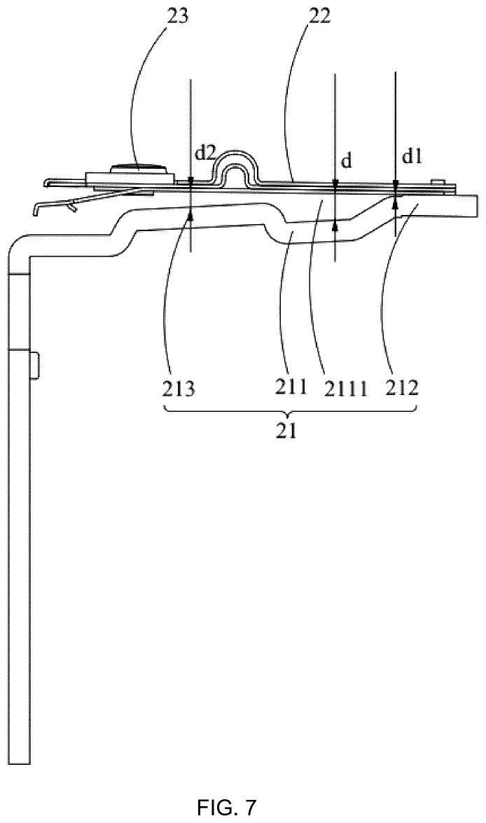

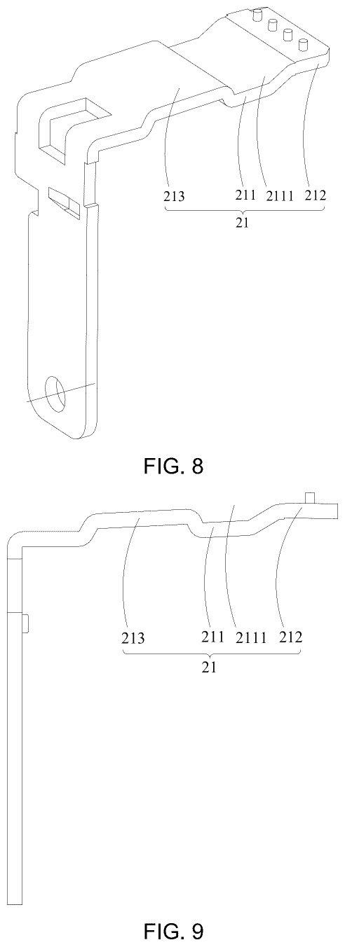

In an embodiment, as shown in FIG. 6 to FIG. 9, the movable contact leading-out piece 21 includes a middle section 211, a first connection section 212, and a second connection section 213. The middle section 211 is disposed between the movable contact 23 and the connection position of the movable contact piece 22 with the movable contact leading-out piece 21; the first connection section 212 is connected to another end of the movable contact piece 22; the second connection section 213 and the first connection section 212 are respectively disposed at two sides of the middle section 211; and a position of the movable contact 23 corresponds to the second connection section 213. A distance from a side of the middle section 211 to a side of the movable contact piece 22 close to the side of the middle section is d; a distance from a side of the first connection section 212 to the side of the movable contact piece 22 close to the side of the first connection section is d1; and a distance from a side of the second connection section 213 to the side of the movable contact piece 22 close to the side of the second connection section is d2, in which d>d1 and d>d2.

For the movable contact piece 22, the current may only exist between the riveting position of the movable contact piece 22 and the movable contact 23, the middle section 211 is configured as the at least part of the movable contact leading-out piece 21, and a region covered by the middle section 211 can match with the region where the current may be generated, to limit the functional region of the movable contact piece 22. The second connection section 213 and the first connection section 212 are respectively disposed at two sides of the middle section 211, the middle section 211 functions as an intermediate connection between the first connection section 212 and the second connection section 213, and the second connection section 213 and the first connection section 212 are substantially portions located at two sides of the middle section 211. The first connection section 212 is connected to another end of the movable contact piece 22 to realize the connection between the first connection section 212 and the movable contact piece 22, in which the first connection section 212 and the movable contact piece 22 may be fixed by rivets. Since there is only one fixing point position between the first connection section 212 and the movable contact piece 22, the V-shaped structure is formed between the movable contact piece 22 and the movable contact leading-out piece 21.

For a distance from the movable contact leading-out piece 21 and the movable contact piece 22, the distance d from the side of the middle section 211 to the side of the movable contact piece 22 close to the side of the middle section is set to be greater than the distance d1 from the side of the first connection section 212 to the side of the movable contact piece 22 close to the side of the first connection section, and is set to be greater than the distance d2 from the side of the second connection section 213 to the side of the movable contact piece 22 close to the side of the second connection section, that is, the distance from the middle section 211 to the movable contact piece 22 is relatively large, so that the electro-dynamic repulsion force between the middle section 211 and the movable contact piece 22 is relatively small, and the amount of deformation of the movable contact piece 22 correspond to the middle section 211 is relatively small, thereby achieving an effect of reducing the upward deformation of the movable contact piece 22 between the movable contact 23 and the riveting position. Since the distance from the first connection section 212 to the movable contact piece 22 and the distance from the second connection section 213 to the movable contact piece 22 are relatively small, the electro-dynamic repulsion force between the second connection section 213 and the movable contact piece 22 is relatively large, and the amount of deformation of the movable contact piece 22 correspond to the second connection section 213 is relatively large. Since the second connection section 213 and the movable contact 23 are disposed correspondingly, the contact pressure between the movable contact 23 and the static contact 12 is relatively large. and at this time the movable contact 23 applies an upward abutting force to the static contact 12, thereby ensuring the contact stability between the movable contact 23 and the static contact 12, and improving the safety of using the relay. At the same time, the electro-dynamic repulsion force between the first connection section 212 and the movable contact piece 22 is relatively large, so that the amount of deformation of the movable contact piece 22 correspond to the first connection section 212 is relatively large, but the first connection section 212 and the movable contact piece 22 are fixed by rivets and hence can resist a certain amount of electro-dynamic repulsion force.

It can be understood that, under a joint action of the first connection section 212, the middle section 211 and the second connection section 213, when a large short-circuit current occurs, the movable contact piece 22 in the related art resembles a structure in which the intermediate portion deforms upward and both ends deform downward, but a gap between the movable contact piece 22 and the middle section 211 according to this embodiment is increased, a repulsion force is decreased, and an upward deformation is decreased, thereby reducing the downward amplitude at both ends, effectively changing a direction of deformation of the movable contact piece 22, and reducing a situation that the movable contact 23 and the static contact 12 detach from each other in the case of a large short-circuit.

It can be understood that the first connection section 212, the middle section 211 and the second connection section 213 form an integrally formed structure, which reduces the time for producing and assembling multiple parts and saves production costs.

In an embodiment, as shown in FIG. 6 to FIG. 9, a projection of the middle section 211 on the movable contact piece 22 does not coincide with a projection of the movable contact 23 on the movable contact piece 22.

If the projection of the middle section 211 on the movable contact piece 22 coincides with the projection of the movable contact 23 on the movable contact piece 22, in other words, the movable contact 23 and the middle section 211 are disposed squarely corresponding to each other, and since the distance from the middle section 211 to the movable contact piece 22 is relatively large, the electro-dynamic repulsion force between the middle section 211 and the movable contact piece 22 is relatively small, so that the abutting force of the movable contact 23 on the static contact 12 is relatively small, and a risk that the movable contact 23 and the static contact 12 detach from each other may easily occur. Accordingly, the projection of the middle section 211 on the movable contact piece 22 does not coincide with the projection of the movable contact 23 on the movable contact piece 22, so that the middle section 211 and the movable contact 23 are staggered with each other, and a relatively small electro-dynamic repulsion force between the middle section 211 and the movable contact piece 22 does not act on a part of the movable contact piece 22 corresponding to the movable contact 23, thereby avoiding a relatively small abutting force of the movable contact 23 on the static contact 12 when a large short-circuit current exists, and ensuring the stability of abutting between the movable contact 23 and the static contact 12.

In an embodiment, the movable contact leading-out piece 21 is recessed in a direction away from the movable contact piece 22, to form the middle section 211.

A distance from the movable contact leading-out piece 21 and the movable contact piece 22 is merely equivalent to a distance between opposite side walls of the V-shaped structure in the prior art. In order to ensure that the distance from the middle section 211 to the movable contact piece 22 is relatively large, the movable contact leading-out piece 21 is recessed in the direction away from the movable contact piece 22, so as to realize a purpose of increasing the distance from the movable contact leading-out piece 21 and the movable contact piece 22. The way of forming the middle section 211 by recessing is simple in structure, easy and convenient in process, and low in production cost.

In an embodiment, the middle section 211 is a groove 2111 with an open structure at one end, and an open end of the groove 2111 faces the movable contact piece 22.

The recess is equivalent to a sunken structure, and compared with the case where the groove 2111 is not provided, at least a distance from a groove bottom of the groove 2111 to the corresponding part of the movable contact piece 22 is increased, thereby improving a local structure of the movable contact leading-out piece 21, making the electro-dynamic repulsion force between the groove bottom of the groove 2111 and the movable contact piece 22 relatively small, and reducing the amount of deformation of the movable contact piece 22 in a region corresponding to the middle section 211.

In an embodiment, another part of the movable contact leading-out piece 21 that is not provided with the groove 2111 includes the first connection section 212 and the second connection section 213.

It can be understood that the part of the movable contact leading-out piece 21 that is not provided with the groove 2111 includes portions at both sides of the groove 2111, and the two portions may be directly used as the first connection section 212 and the second connection section 213, that is, the first connection section 212 and the second connection section 213 can be formed naturally at the same time simply after the middle section 211 is processed, which simplifies the process and lowers the production cost.

In an embodiment, a groove wall of the groove 2111 is of an arcuate structure or a linear structure; and/or the groove bottom of the groove 2111 is of an arcuate structure or a linear structure.

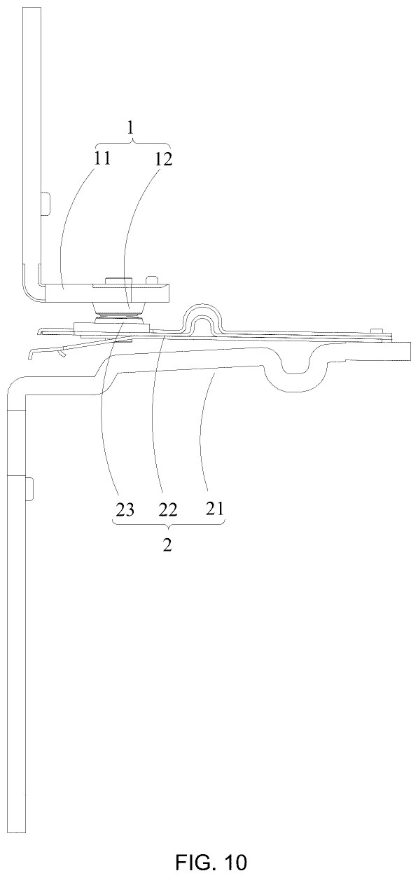

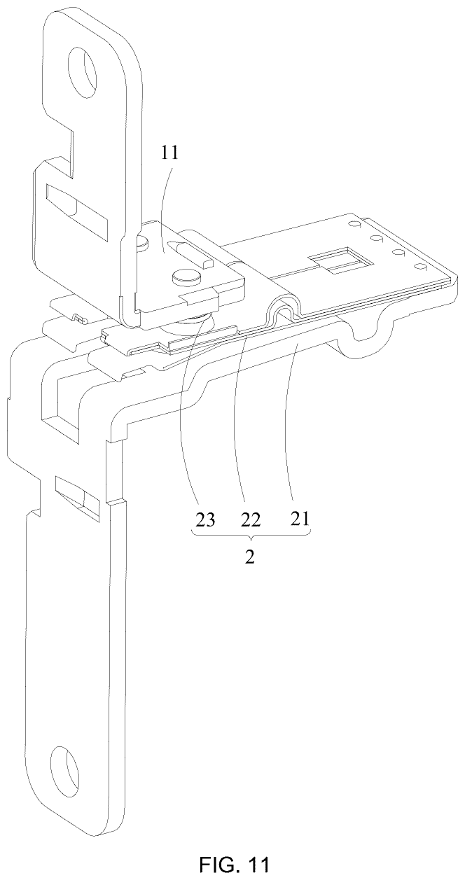

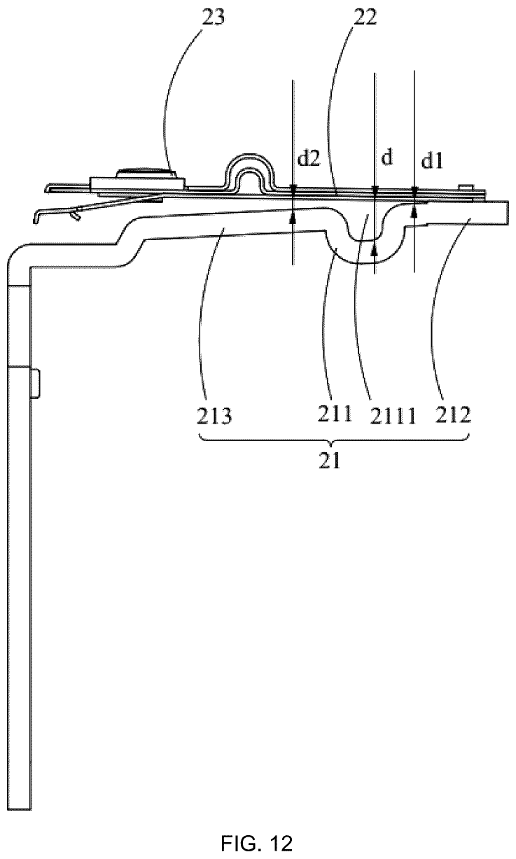

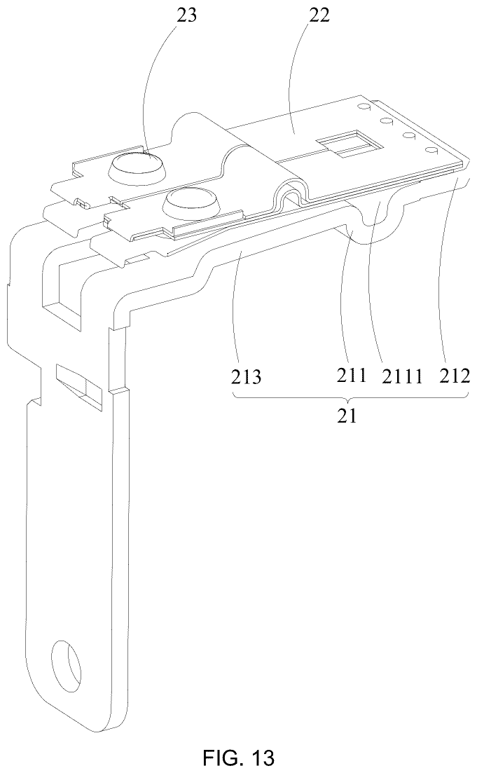

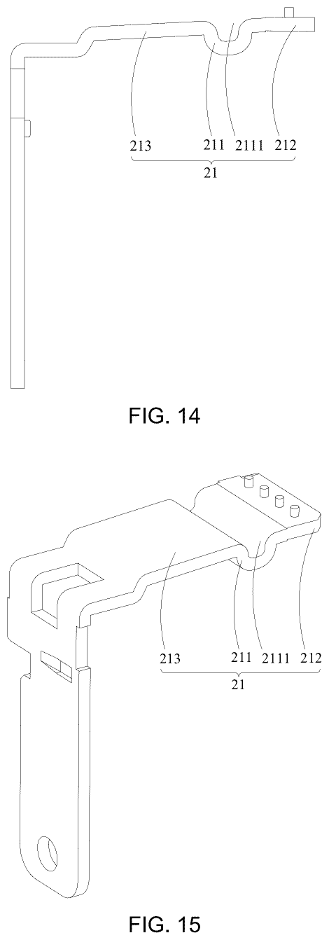

As shown in FIG. 6 to FIG. 9, if the groove wall of the groove 2111 is of a linear structure, and/or the groove bottom of the groove 2111 is of a linear structure, at least a part of an inner wall of the groove 2111 is of an angular structure; if the groove wall and the groove bottom of the groove 2111 are each of a linear structure, the groove 2111 may be specifically a rectangular groove or a trapezoidal groove. As shown in FIG. 10 to FIG. 15, if the groove wall of the groove 2111 is of an arcuate structure, and/or the groove bottom of the groove 2111 is of an arcuate structure, the arcuate structure plays a role of smooth transition; if the groove wall and the groove bottom of the groove 2111 are each of an arcuate structure, the groove 2111 may be specifically a groove 2111 with a semicircular structure.

It should be noted that if a side wall of the groove 2111 is disposed in parallel to the movable contact piece 22, the groove 2111 cannot be formed; if the side wall of the groove 2111 is obliquely disposed relative to the movable contact piece 22, the side wall of the groove 2111 plays a role in increasing the distance to the movable contact piece 22 until a distance from the groove bottom of the groove 2111 to the movable contact piece 22 reaches a maximum distance, and at this time, the side wall and a bottom wall of the groove 2111 both play a role in increasing the distance to some extent. If the side wall of the groove 2111 is disposed perpendicular to the movable contact piece 22, the distance from the side wall of the groove 2111 to the movable contact piece 22 are relatively small, and a direction of the current direction is vertical, which may only increase the distance from the groove bottom of the groove 2111 to the movable contact piece 22.

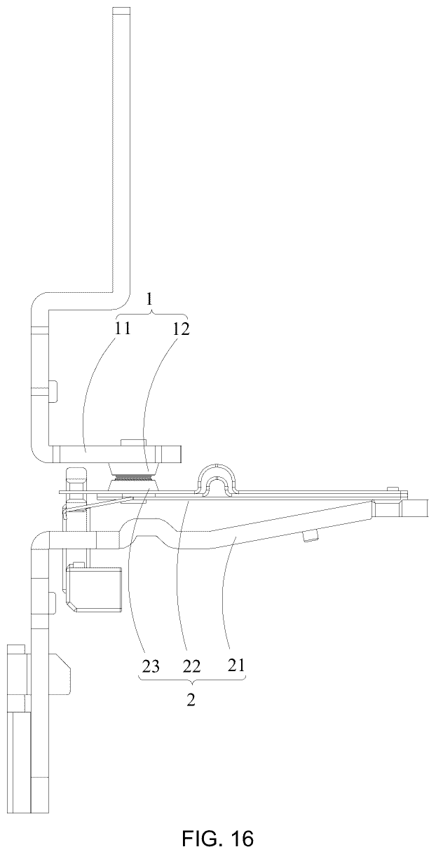

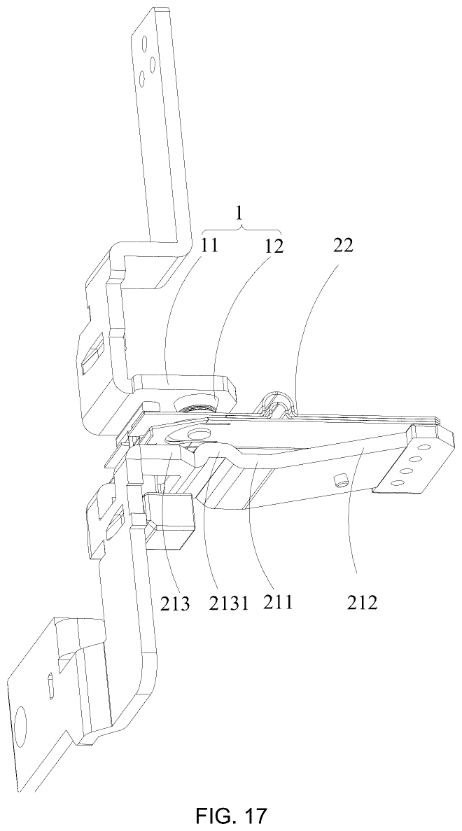

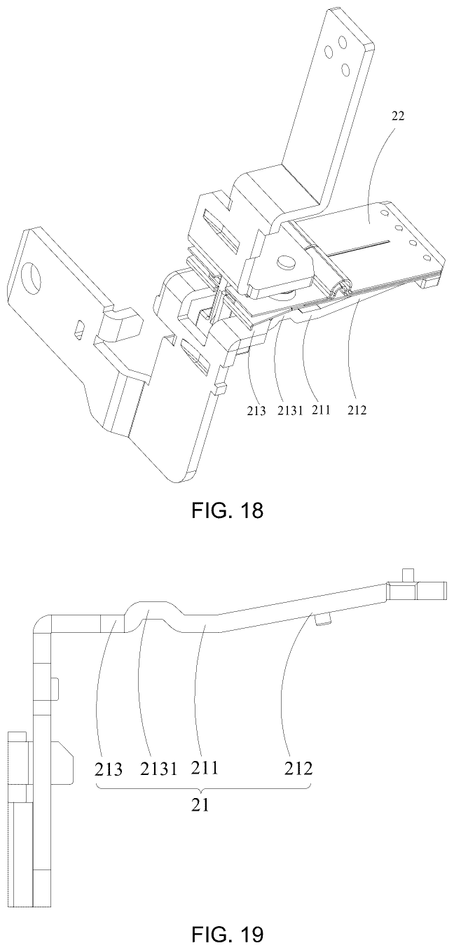

In an embodiment, as shown in FIG. 16 to FIG. 19, an end of the movable contact leading-out piece 21 close to the movable contact 23 at least partially protrudes toward a direction close to the movable contact piece 22, to form the second connection section 213.

It can be understood that, in order to reduce the amount of deformation and change the direction of deformation of the movable contact piece 22, besides an increase in the distance from the middle section 211 to the movable contact piece 22, a way of reducing the distance from the second connection section 213 to the movable contact piece 22 may also be adopted. Accordingly, at least a part of an end of the movable contact leading-out piece 21 close to the movable contact 23 protrudes toward the direction close to the movable contact piece 22, to form the second connection section 213, which is equivalent to reducing the distance from the second connection section 213 to the movable contact piece 22. Based on a principle that the smaller the distance is, the larger the electro-dynamic repulsion force is, the electro-dynamic repulsion force between the second connection section 213 and the movable contact piece 22 is relatively large. Due to the corresponding positioning of the second connection section 213 and the movable contact 23, the second connection section 213 can provide a large upward abutting force for the movable contact 23, thereby ensuring the contact stability between the movable contact 23 and the static contact 12. The way of forming the second connection section 213 by protruding is simple in structure, easy and convenient in process, and low in production cost.

In an embodiment, the second connection section 213 includes a protrusion 2131 that protrudes relative to the movable contact leading-out piece 21 and in a direction close to the movable contact piece 22, and the middle section 211 is formed between a side wall of the protrusion 2131 close to the first connection section 212 and the first connection section 212.

It can be understood that a top wall of the protrusion 2131 is at a position where the protrusion 2131 is closest to the movable contact piece 22, and a distance from the side wall of the protrusion 2131 to the movable contact piece 22 tends to gradually increase. Forming the middle section 211 between the side wall of the protrusion 2131 close to the first connection section 212 and the first connection section 212 is equivalent to using a space between the side wall of the protrusion 2131 and the first connection section 212 as the middle section 211. Since the distance from the side wall of the protrusion 2131 to the movable contact piece 22 gradually increases, it can be ensured that the distance between the middle section 211 and the movable contact piece 22 is relatively large.

In an embodiment, as shown in FIG. 16 to FIG. 19, a projection of the protrusion 2131 on the movable contact piece 22 at least partially coincides with the projection of the movable contact 23 on the movable contact piece 22.

The protrusion 2131 is disposed approximately squarely corresponding to the movable contact 23. That is, a position where the second connection section 213 is closest to the movable contact piece 22 corresponds to the movable contact 23, which is equivalent to that the movable contact leading-out piece 21 is additionally bent near the movable contact 23, so that an electromagnetic force near the movable contact 23 is enhanced, the electro-dynamic repulsion force is locally improved, the movable contact 23 is prevented from being repelled open under the short-circuit current, and a relatively large electro-dynamic repulsion force is ensured to be directly converted into the upward abutting force of the movable contact 23 on the static contact 12, thereby achieving a function of tightly combining the movable contact 23 and the static contact 12.

In an embodiment, the projection of the protrusion 2131 on the movable contact piece 22 completely coincides with the projection of the movable contact 23 on the movable contact piece 22.

The protrusion 2131 is completely squarely corresponding to the movable contact 23, and a central axis of the protrusion 2131 is collinear with a central axis of the movable contact 23, so as to ensure a correspondence and matching effect between the protrusion and the movable contact 23, thereby ensuring that the relatively large electro-dynamic repulsion force is directly converted into the upward abutting force of the movable contact 23 on the static contact 12.

In an embodiment, a part of the projection of the protrusion 2131 on the movable contact piece 22 beyond the projection of the movable contact 23 on the movable contact piece 22 is located at a side of the movable contact 23 close to the connection position of the movable contact piece 22 with the movable contact leading-out piece 21.

When a short circuit occurs, after the current passing through the movable contact leading-out piece 21 reaches the riveting position between the movable contact piece 22 and the movable contact leading-out piece 21, the current is transmitted to the movable contact 23 through the movable contact piece 22. For the movable contact piece 22, the current may only exist between the riveting position of the movable contact piece 22 and the movable contact 23, so that no current passes through a side of the movable contact piece 22 corresponding to the movable contact 23 away from the riveting position, that is, no electro-dynamic repulsion force exists between a left region of the movable contact piece 22 bounded by the movable contact 23 and the movable contact leading-out piece 21, which is an ineffective region. Since the part by which the projection of the protrusion 2131 on the movable contact piece 22 is beyond the projection of the movable contact 23 on the movable contact piece 22 is located at the side of the movable contact 23 close to the connection position of the movable contact piece 22 with the movable contact leading-out piece 21, the central axis of the protrusion 2131 may be offset relative to the central axis of the movable contact 23. Since the central axis of the protrusion 2131 is offset rightward relative to the movable contact 23, it is ensured that the protrusion 2131 is bent upward in a current flow path, and that the movable contact piece 22 generates an electro-dynamic repulsion force between a right region of the movable contact piece 22 bounded by the movable contact 23 and the movable contact leading-out piece 21, so as to ensure the effectiveness of reducing the distance at the movable contact 23.

As shown in FIG. 1, the relay according to this embodiment further includes an insulating housing and a microswitch 109. The insulating housing is formed by fixedly connecting a base 100 and a cover (not shown) through clamping. The base 100 and the cover are both made by injection molding of plastic materials. The base 100 is provided with a magnetic circuit system and two push cards 101. The magnetic circuit system includes an armature assembly 102, a coil 103, and a yoke 104. The yoke 104 is fixedly connected to a coil bobbin, and the coil 103 and the yoke 104 are fixed to one side of the base 100. The middle of the armature assembly 102 is pivotally connected to the base 100 and located next to the coil 103. A pivot shaft 106 extends outward from the middle of an upper end and of a lower end of the armature assembly 102, and central axes of the two pivot shafts 106 coincide. One pivot shaft 106 is inserted into a pivot hole (not shown) of the base 100, while the other pivot shaft 106 is fitted with a socketed hole 107 of a pressing block 105, and two ends of the pressing block 105 are fixedly connected to the base 100.

When the coil 103 of the relay is energized by a forward pulse voltage, the magnetic circuit system works, the armature assembly 102 drives the push cards 101, and in turn the push cards 101 push the movable contact piece 22 to shift, so that the movable contact 23 is in contact with the static contact 12, the relay is in a connected state, a pressing rod 108 releases the microswitch 109 to contact the movable contact piece 22, the microswitch 109 resets and does not act, and the microswitch 109 also transmits one of its state to the outside through a conductive plug terminal 110. When the coil 103 of the relay is energized by a reverse pulse voltage, the magnetic circuit system works again, the armature assembly 102 drives the push cards 101 to return, and in turn the push cards 101 pull the movable contact piece 22 to return, so that the movable contact 23 is separated from the static contact 12, i.e., the contacts are disconnected, the relay is in a disconnected state, the pressing rod 108 presses the microswitch 109 to contact the movable contact piece 22, hence the microswitch 109 acts, and the microswitch 109 transmits another state to the outside through the conductive plug terminal 110. As a result, the working state of the relay can be conveniently determined by judging the state of the microswitch 109.

For the relay according to the embodiments of the present disclosure, one end of the movable contact piece is provided with the movable contact at the side facing the static contact, that is, the movable contact is fixed at one end of the movable contact piece and corresponds to the static contact, and another end of the movable contact piece is connected to the movable contact leading-out piece, so that the movable contact piece and the movable contact leading-out piece are connected as an integral structure. In the existence of current, since the movable contact leading-out piece and the movable contact piece forms a V shape, a current flowing through the movable contact leading-out piece and a current flowing through the movable contact piece must be in opposite directions, at which time the electro-dynamic repulsion force is generated between the movable contact leading-out piece and the movable contact piece, and the electro-dynamic repulsion force acting on the movable contact piece will increase pressure between the movable contact and the static contact, thereby achieving an anti-short circuit ability.

When a short circuit occurs, after the current passing through the movable contact leading-out piece reaches the riveting position between the movable contact piece and the movable contact leading-out piece, the current is transmitted to the movable contact through the movable contact piece. The current may only exist between the riveting position of the movable contact piece and the movable contact, so that a region between the movable contact and the connection position of the movable contact piece with the movable contact leading-out piece can match with a region where the current may be generated, to limit a functional region of the movable contact piece. When a short-circuit current occurs, since the distance from at least part of the movable contact leading-out piece to the movable contact piece is relatively large, the electro-dynamic repulsion force between the at least part of the movable contact leading-out piece and the movable contact piece is relatively small, and the amount of deformation of the movable contact piece in this region is relatively small, so as to achieve the purpose of reducing the upward deformation of the movable contact piece in this region. Since the distance from portions of the movable contact leading-out piece located at both sides of the at least part to the movable contact piece is relatively small, the electro-dynamic repulsion force between the portions of the movable contact leading-out piece located at both sides of the at least part and the movable contact piece is relatively large, so that the amount of deformation of the movable contact piece in this region is relatively large, and contact pressure between the movable contact and the static contact is relatively large, reducing a risk of staggered displacement occurring between the movable contact and the static contact, reducing the occurrence of explosions due to the instability caused by the short circuit, and improving the safety during use of the relay.

It should be understood that the present disclosure does not limit its application to the detailed structures and arrangements of components presented herein. The present disclosure may have other embodiments and be realized and performed in a variety of ways. The foregoing variations and modifications fall within the scope of the present disclosure. It should be understood that the present disclosure as disclosed and defined in this specification extends to all alternative combinations of two or more individual features mentioned or apparent in the text and/or in the drawings. All of these various combinations constitute a plurality of alternative aspects of the present disclosure. The embodiments described in this specification elaborate the best ways known for realizing the present disclosure and will enable those skilled in the art to utilize the present disclosure.

1. A relay, comprising:
a static contact; and
a movable contact assembly, comprising:
a movable contact leading-out piece,
a movable contact piece, and
a movable contact disposed at a side of one end of the movable contact piece, facing the static contact,
wherein another end of the movable contact piece is connected to the movable contact leading-out piece, the movable contact piece is located between the static contact and the movable contact leading-out piece and is configured to generate an electro-dynamic repulsion force between the movable contact piece and the movable contact leading-out piece under a short-circuit current, to allow the movable contact to abut against the static contact;
wherein between the movable contact and a connection position of the movable contact piece with the movable contact leading-out piece, a distance from at least part of the movable contact leading-out piece to the movable contact piece is greater than a distance from portions of the movable contact leading-out piece located at both sides of the at least part to the movable contact piece.

2. The relay according to claim 1, wherein the movable contact piece and the movable contact leading-out piece form a V-shaped structure.

3. The relay according to claim 1, wherein the movable contact leading-out piece comprises:
a middle section disposed between the movable contact and the connection position of the movable contact piece with the movable contact leading-out piece, the middle section being the at least part of the movable contact leading-out piece;
a first connection section connected to another end of the movable contact piece; and
a second connection section, the second connection section and the first connection section being respectively disposed at two sides of the middle section, and a position of the movable contact corresponds to the second connection section,
wherein a distance from a side of the middle section to a side of the movable contact piece close to the side of the middle section is d; a distance from a side of the first connection section to the side of the movable contact piece close to the side of the first connection section is d1; and a distance from a side of the second connection section to the side of the movable contact piece close to the side of the second connection section is d2, wherein d>d1 and d>d2.

4. The relay according to claim 3, wherein a projection of the middle section on the movable contact piece does not coincide with a projection of the movable contact on the movable contact piece.

5. The relay according to claim 4, wherein the movable contact leading-out piece is recessed in a direction away from the movable contact piece, to form the middle section.

6. The relay according to claim 5, wherein the middle section is a groove with an open structure at one end, and an open end of the groove faces the movable contact piece.

7. The relay according to claim 6, wherein another part of the movable contact leading-out piece that is not provided with the groove is the first connection section and the second connection section.

8. The relay according to claim 6, wherein a groove wall of the groove is of an arcuate structure or a linear structure; and/or
a groove bottom of the groove is of an arcuate structure or a linear structure.

9. The relay according to claim 4, wherein an end of the movable contact leading-out piece close to the movable contact at least partially protrudes toward a direction close to the movable contact piece, to form the second connection section.

10. The relay according to claim 9, wherein the second connection section comprises a protrusion that protrudes relative to the movable contact leading-out piece and in a direction close to the movable contact piece, and the middle section is formed between a side wall of the protrusion close to the first connection section and the first connection section.

11. The relay according to claim 10, wherein a projection of the protrusion on the movable contact piece at least partially coincides with a projection of the movable contact on the movable contact piece.

12. The relay according to claim 11, wherein the projection of the protrusion on the movable contact piece completely coincides with the projection of the movable contact on the movable contact piece.

13. The relay according to claim 11, wherein a part of the projection of the protrusion on the movable contact piece beyond the projection of the movable contact on the movable contact piece is located at a side of the movable contact close to the connection position of the movable contact piece with the movable contact leading-out piece.

14. The relay according to claim 1, wherein the distance from at least part of the movable contact leading-out piece to the movable contact piece refers to a distance from the movable contact to a straight line connecting the movable contact and the connection position of the movable contact piece with the movable contact leading-out piece when the movable contact and corresponding static contact are closed.

15. The relay according to claim 5, wherein the movable contact leading-out piece is recessed in a direction away from the movable contact piece, to form the middle section.

16. The relay according to claim 5, wherein an end of the movable contact leading-out piece close to the movable contact at least partially protrudes toward a direction close to the movable contact piece, to form the second connection section.
